(19) United States
(12) Patent Application Publication
(10) Pub. No.: US 2009/0010412 A1
(43) Pub. Date: Jan. 8, 2009

(54) Method and Device for Setting Up a Priority Communication

(75) Inventors: Laura Carlier, Guirec (FR); Vincent Teze, Landeda (FR); Claude Daloz, Lannion (FR)

Correspondence Address: COHEN, PONTANI, LIEBERMAN & PAVANE LLP, 551 FIFTH AVENUE, SUITE 1210, NEW YORK, NY, 10176, US

(73) Assignee: France Telecom, Paris (FR)

(21) Appl. No.: 12/278,766

(22) PCT Filed: Jan. 25, 2007
(86) PCT No.: PCT/FR2007/050695

§ 371 Date: Aug. 7, 2008

(30) Foreign Application Priority Data
Feb. 7, 2006 (FR) 0650425

(51) Int. Cl. H04M 3/42

(52) U.S. Cl. 379/208.01

(57) ABSTRACT

This method enables a priority call (C_{AB}) to be set up between a first terminal (A) and a second terminal (B), while a first call (C_{BC}) is already set up (E10) between the second terminal (B) and a third terminal (C). The method includes a step (E40, E50) of suspending the first call (C_{BC}) at the initiative of the first terminal (A).

### BACKGROUND OF THE INVENTION

The field of the invention is that of managing calls for the purpose of setting up calls between people in a telecommunications network, where the network may be of any type, and in particular it may be of the “circuit switched” type or of the “packet switched type”.

The invention relates more particularly to managing urgent calls and seeks to make it possible, when such a call occurs, to set up a priority call with a terminal that is already in communication with another terminal.

In known manner, when a terminal calls a terminal that is already in communication, it receives a signal representative of the fact that the called terminal is busy.

In the present state of the art, there exist services that make it possible to send a “call-waiting” signal to a terminal that is already in communication in order to inform the user that another terminal is seeking to make a call thereto.

However that signal is for information purposes only, insofar as it leaves it up to the user of the already-busy terminal to decide whether or not to switch to the new incoming call.

### OBJECT AND SUMMARY OF THE INVENTION

The present invention seeks to provide a method and apparatus making it possible for a terminal calling a terminal that is already engaged on a call to suspend that call in order to set up a priority call.

More precisely, in a first aspect, the invention provides a method of setting up a priority call between a first terminal and a second terminal, a first call already being set up between said second terminal and a third terminal. The method comprises, prior to setting up said priority call, a step of suspending said first call at the initiative of said first terminal.

Thus, unlike the state of the art constituted by call-waiting services, the current call is suspended by the first terminal and not by the user of the second terminal.

In a particular implementation, the user of the first terminal can, when making an urgent call, suspend the on-going call in order to force the second terminal to enter into communication therewith.

In a particular implementation, the call set-up method of the invention includes, prior to said suspension step, a step during which it is verified whether said first terminal is authorized to suspend said first call.

In this particular implementation, the option of interrupting the on-going call is made available only if the caller is duly authorized by the called party to perform this operation.

For example, the verification may consist in searching whether the caller is entered in a directory of the called party in association with appropriate rights.

In a particular implementation, interruption may be automatic.

In a particular implementation, interruption may be automatic providing the calling person is in the list of callers authorized to interrupt on-going calls on the second terminal.

In a particular implementation, the call set-up method of the invention includes, prior to said suspension step, a step in which said first terminal confirms that said suspension should be proceeded with.

In this implementation, interruption is not automatic: it is subject to approval of the caller, e.g. by playing a voice recording that proposes interrupting the on-going call of the called party. The caller may then, for example, confirm that the on-going call should be suspended by keying in a sequence of dual tone multifrequency (DTMF) keys.

In a particular embodiment of the invention, the call set-up method includes at least one of the following steps:
putting on hold at least one of said terminals prior to setting up said priority call; and
putting on hold said third terminal during said priority call.

In a particular implementation, the two parties initially on a call can be warned by playing an audio/video recording concerning the arrival of the call from the first terminal. At the end of the recording, the initial on-going call is suspended and the priority call is set up.

During the priority call, the initial party using the third terminal, i.e. the party not involved in the priority call, can be put on hold with a sound track inviting that party to wait.

In a particular implementation, the invention includes a step of setting up said first call again at the end of said priority call.

In a particular implementation of the invention, said priority call is set up for a predetermined duration.

The invention also provides telecommunications apparatus comprising:
means for suspending, at the initiative of a first terminal, a first call already set up between a second terminal and a third terminal; and
means for setting up a priority call between said first terminal and said second terminal.

The invention also provides an SIP server including telecommunications apparatus as specified above.

In known manner, an SIP server is adapted to implement the SIP protocol as defined by the Internet engineering task force (IETF) in document RFC 3261.

The SIP proxy of the invention is adapted to implement the SIP protocol.

In particular, it is adapted to use its communications means 104 to issue BYE messages for ending a call between two terminals, and INVITE messages for setting up a call between two terminals.

In a particular embodiment, the various steps of the priority call set-up method are determined by instructions of computer programs.

Consequently, the invention also provides a computer program on a data medium, the program being suitable for being implemented in priority call set-up apparatus, or more generally in a computer, the program including instructions adapted to implementing steps of a priority call set-up method as described above.

The program can use any programming language, and may be in the form of source code, object code, or code that is intermediate between source code and object code, such as in a partially compiled form, or in any other desirable form.

The invention also provides an information medium that is readable by a computer, and that includes instructions of a computer program as mentioned above.

The data medium may be any entity or device capable of storing the program. By way of example, the medium may comprise storage means such as read-only memory (ROM), e.g. a CD-ROM, or a microelectronic circuit ROM, or indeed it may comprise magnetic recording means, e.g. a floppy disk or a hard disk.

Furthermore, the data medium may be a transmission medium such as an electrical or optical signal, that can be conveyed via an electrical or optical cable, by radio, or by other means. The program of the invention may in particular be downloaded from a network of the Internet type.

Alternatively, the data medium may be an integrated circuit in which the program is incorporated, which circuit is adapted to execute, or to be used in the execution of, the method in question.

### BRIEF DESCRIPTION OF THE DRAWINGS

Other characteristics and advantages of the present invention appear from the following description made with reference to the accompanying drawings that show an implementation having no limiting character. In the figures:

FIG. 1 shows a particular embodiment of an SIP proxy of the invention in its environment; and

FIGS. 2 and 3 are diagrams showing the main steps of a method of setting up a priority call in accordance with a preferred implementation.

### DETAILED DESCRIPTION OF AN IMPLEMENTATION

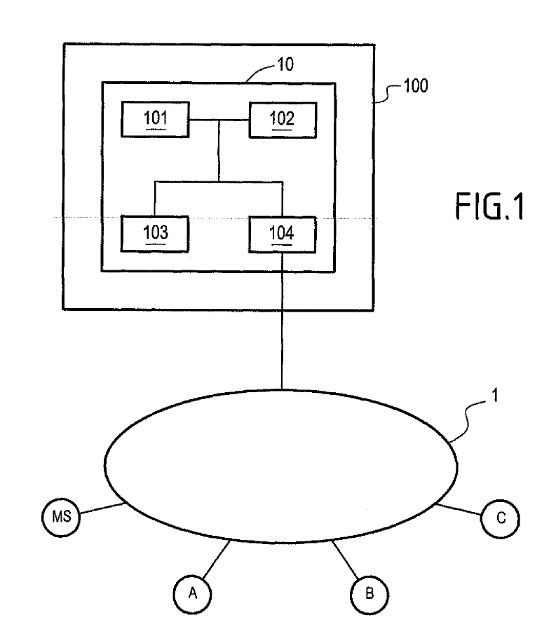

FIG. 1 shows an SIP server 100 in accordance with the invention.

The SIP server 100 includes telecommunications apparatus 10 in accordance with the invention.

In the embodiment described herein, the SIP server 100 is constituted by a computer.

It comprises a processor 101, a ROM 102, a random-access memory (RAM) 103, and communications means 104.

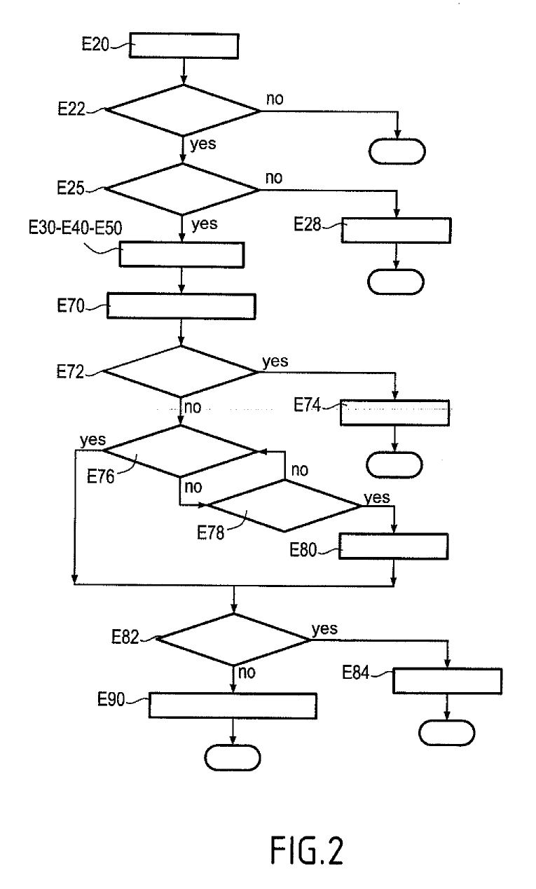

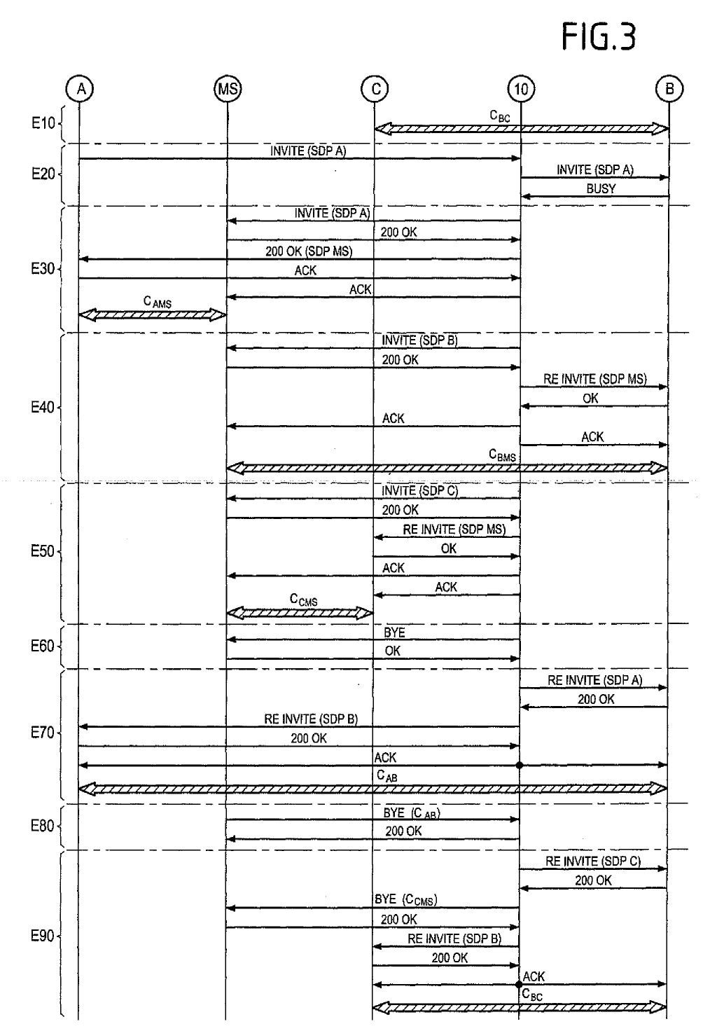

The ROM 102 contains a computer program in accordance with the invention, and the main steps thereof are described below with reference to FIGS. 2 and 3.

It is connected via its communications means 104 to a telecommunications network 1 having connected thereto terminals A, B, and C that operate in application of the SIP protocol.

The network is also shown as including a content server MS adapted to play voice recordings to the users of terminals A, B, and C.

In known manner, the SIP protocol server places itself in series in the SIP signaling for calls established between terminals A, B, and C.

With reference to FIGS. 2 and 3, it is assumed that a call C_{BC} has been set up in application of the SIP protocol between terminals C and B during a step E10.

It is assumed that during a step E20, the terminal A initiates a call to terminal B that is already on a call C_{BC} with terminal C.

In the SIP protocol, terminal A issuing a call gives rise to sending an INVITE request that contains, in accordance with RFC 2327, a session description protocol (SDP) part containing the parameters of terminal A (address, port, codecs supported by the terminal).

This call request is intercepted by the SIP server 10 in accordance with the invention that is placed, as mentioned above, in series between terminal A and terminal B.

During the same step E20, the SIP server 10 forwards the request INVITE(SDP A) to terminal B.

Since terminal B is already on a call C_{BC} with terminal C, it responds to this INVITE message by sending a BUSY message indicating that it is in a busy state.

The BUSY message is intercepted by the SIP server 10 in accordance with the invention.

Given that the terminal B is busy, it is verified during a step E22 whether terminal A is authorized to interrupt the first call C_{BC} when the terminal B is busy.

In the implementation described herein, this amounts to interrogating a database (not shown) having entered therein all of the terminals for which the user of terminal B has given an authorization for this purpose.

If terminal A is not so authorized, the result of test E22 is negative and the method terminates.

In the example described below, it is assumed that such authorization has been given for terminal A and that the result of test E22 is positive.

This test is then followed by a confirmation step E25 during which the user of terminal A is asked if he or she desires to suspend the first call C_{BC}.

This confirmation step is performed in the example described by sending an audio recording to the user of terminal A who can agree or decline by sending a DTMF sequence.

When the user of terminal A declines, the result of test E25 is negative.

This test is then followed by a step E28 during which an announcement is played to terminal A, this announcement terminating the call-setup procedure.

If the user sends a DTMF sequence representing confirmation that suspension should be proceeded with, then the result of test E25 is positive.

This test is then followed by three steps E30, E40, and E50 during which the terminals A, B, and C are put respectively into connection with the content server MS.

These steps E30, E40, and E50 are described below in greater detail with reference to FIG. 3.

Step E30 of putting terminal A into connection with the content server MS comprises the SIP server 10 sending a message INVITE(SDP A) to the content server MS, where the parameters SDP A were obtained by the SIP server 10 during the above-described step E20.

On receiving this INVITE request, the content server MS sends a positive response 200 OK to the SIP server.

The SIP server 10 then sends a positive response 200 OK to the terminal A in response to its invitation message INVITE(SDP A) of step E20.

This positive responses message 200 OK includes the parameters SDP MS of the content server MS.

The terminal A acknowledges this response message by sending an acknowledgment ACK to the SIP server 10.

The SIP server 10 can thus acknowledge receiving the message 200 OK received from the content server MS by sending an acknowledgment ACK.

A call C_{AMS} is then established between the terminal A and the content server MS whereby the content server MS plays a recording inviting the user of terminal A to wait until put into connection with terminal B.

There follows a description with reference to step E40 about how the SIP server 10 puts the content server MS into connection with the terminal B, which terminal B is already on a call C_{BC} with terminal C.

Firstly, the SIP server 10 sends a request INVITE(SDP B) to the content server MS.

The parameters SDP B are known to the SIP server 10 since it was in a position to obtain them while setting up the call C_{BC} (step E10), given that it is placed in series.

The content server MS responds to this invitation message by sending a call accept response 200 OK.

On receiving this response, the SIP server sends a message RE INVITE(SDP MS) to the terminal B, this message containing the parameters MS concerning the content server MS.

The terminal B responds positively to this message RE INVITE by sending the response OK.

The SIP server 10 can then acknowledge the response 200 OK from the content server MS by sending an acknowledgment ACK thereto.

Similarly, the SIP server 10 acknowledges the OK response received from the terminal B by sending an acknowledgment ACK.

A call C_{BMS} is then set up between the content server MS and the terminal B, the content server MS then being in a position to play an appropriate recording to the terminal B.

Step E50 of connecting the terminal C with the content server MS is identical to step E40 and is not described herein.

Thus, at the end of step E50, each of the terminals A, B, and C is in connection with the content server MS.

In a variant, the terminals A, B, and C may be put into connection with different content servers.

The above-described steps E40 and E50 thus lead to the first call C_{BC} being suspended.

During a step E60, the SIP server 10 in accordance with the invention sends a request BYE to the content server MS asking it to interrupt the calls C_{AMS} and C_{BMS} that it has set up respectively with terminal A and with terminal B.

It is assumed that the content server MS responds positively by sending a message OK to the SIP server 10.

Thereafter, during a step E70, the SIP server 10 sets up a call C_{AB} between the terminals A and B.

To do this, it begins by sending a request RE INVITE(SDP A) to the terminal B which responds positively thereto (message 200 OK), and then sends a message RE INVITE(SDP B) to the terminal A, which likewise responds positively thereto (response 200 OK).

On receiving both positive responses (200 OK), the proxy SIP server 10 sends respective acknowledgments ACK to the terminals A and B.

The call C_{AB} is thus set up with priority over the call C_{BC} that was initially in progress, and it is set up at the initiative of the terminal A.

In the example described herein, step E70 of setting up the priority call C_{AB} is followed by a test E72 during which it is verified whether terminal B has hung up.

If so, this test is followed by a step E74 during which an announcement is played to terminal C on hold, and the method terminates.

Otherwise, the result of test E72 is negative.

In which case the test is followed by a test E76 during which it is determined whether the priority call C_{AB} has terminated, as can happen, in particular if terminal A has hung up.

If the priority call C_{AB} is still active, the result of test E76 is negative.

This test is then followed by a test E78 during which it is verified whether a predetermined duration measured from the setting up of call C_{AB} has expired.

If so, the priority call C_{AB} is terminated during a step E80.

Either at the end of the predetermined duration (result of test E78 positive), or else when the priority call C_{AB} is terminated (result of test E76 positive), it is verified during a step E82 whether the terminal C that was on hold has hung up.

If so, test E82 is followed by a step E84 during which an announcement is played to terminal B stating this fact and the method terminates.

If terminal C has not hung up, then during a step E90, the call between terminals B and C is set up again, i.e. between the terminals that were in communication before the priority call C_{AB} was set up.

1. A method of setting up (E70) a priority call (C_{AB}) between a first terminal (A) and a second terminal (B), a first call (C_{BC}) already being set up (E10) between said second terminal (B) and a third terminal (C), wherein said method comprises, prior to setting up (E70) said priority call (C_{AB}), a step (E40, E50) of suspending said first call (C_{BC}) at the initiative of said first terminal (A).

2. The call set-up method according to claim 1, comprising, prior to said suspension step (E40, 1350), a step (E22) during which it is verified whether said first terminal (A) is authorized to suspend said first call (C_{BC}).

3. The call set-up method according to claim 1, comprising, prior to said suspension step (E40, E50), a step (E25) in which said first terminal (A) confirms that said suspension should be proceeded with.

4. The call set-up method according to claim 1, comprising at least one of the following steps:
putting on hold (E30, E40, E350) at least one of said terminals (A, B, C) prior to setting up said priority call (C_{AB}); and
putting on hold (E50) said third terminal (C) during said priority call (C_{AB}).

5. The call set-up method according to claim 1, comprising a step of setting up said first call (C_{BC}) again at the end of said priority call (C_{AB}).

6. The call set-up method according to claim 1, wherein said priority call (C_{AB}) is set up for a predetermined duration.

7. A telecommunications apparatus (10), comprising:
means for suspending, at the initiative of a first terminal (A), a first call (C_{BC}) already set up between a second terminal (B) and a third terminal (C); and
means for setting up a priority call (C_{AB}) between said first terminal (A) and said second terminal (B).

8. An SIP server (10) including telecommunications apparatus (9) in accordance with claim 7.

9. A computer program including instructions for executing the steps of the call set-up method according to claim 1, when said program is executed by a computer.

10. A recording medium readable by a computer and having recorded thereon a computer program including instructions for executing the steps of the call set-up method according to claim 1.
